(19) United States
(12) Patent Application Publication
(10) Pub. No.: US 2009/0070024 A1
(43) Pub. Date: Mar. 12, 2009

(54) GPS TRAFFIC LOAD BALANCING SYSTEM CONGESTION PREVENTION

(75) Inventors: Joshua D. Burchard, Somerville, MA (US); Rebecca J. Dudczak, Bedford, MA (US); Phillipe A. Loher, Lowell, MA (US); Irina Ros, Chelmsford, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/851,679

(22) Filed: Sep. 7, 2007

(51) Int. Cl. G06G 7/76

(52) U.S. Cl. 701/117; 701/213

(57) ABSTRACT

A routing system includes: at least one vehicular unit including a global positioning system (GPS) receiver for receiving coordinate information, an interface for receiving destination information and a processing system adapted for two-way communications; and a load balancing system adapted for receiving the coordinate information and the destination information from the at least one vehicular unit and determining a route from congestion data and the information. A method that at least one of avoids congestion and prevents congestion is provided.

### BACKGROUND OF THE INVENTION

1. Field of the Invention

This invention relates to vehicular traffic management, and particularly to a system for using global positioning system (GPS) technology and providing traffic load balancing in order to prevent congestion.

2. Description of the Related Art

Many of today's GPS navigation systems receive traffic congestion information and are able to adjust and suggest a detour to the driver. However, if the congestion has already formed, suggested routes may be determined only once it is too late to avoid the congestion.

What are needed are techniques for providing high quality and timely route information to drivers, such that traffic congestion may be avoided.

### SUMMARY OF THE INVENTION

Disclosed is a routing system including: at least one vehicular unit including a global positioning system (GPS) receiver for receiving coordinate information, an interface for receiving destination information and a processing system adapted for two-way communications; and a load balancing system adapted for receiving the coordinate information and the destination information from the at least one vehicular unit and determining a route from congestion data and the information.

Further disclosed is a method for determining route information for routing from an initial location to a destination, the method including: determining initial coordinates from global position system (GPS) information; calculating an initial route to the destination; evaluating congestion data associated with the route information; and recalculating the route information to avoid congestion.

In addition, a routing system is provided and includes: at least one vehicular unit including a global positioning system (GPS) receiver for receiving coordinate information, an interface for receiving destination information and a processing system adapted for two-way communications; and a load balancing system adapted for receiving the coordinate information and the destination information from the at least one vehicular unit and determining a route from congestion data and the information; wherein the congestion data includes at least one of start coordinates and end coordinates for a road segment; speed limit for the road segment; a vehicle capacity for the road segment; a current load of vehicles for the road segment; current GPS coordinates for the vehicular unit; speed information; demographic information including average traffic count according to day and time; as well as construction information and associated impact information; wherein the route is determined from at least one of a statistical analysis; demographic information; road condition information and a combination thereof.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a traffic routing system includes instructions for determining route information from congestion data, initial location information and destination information.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an example of traffic routing according to a prior art global positioning system (GPS);

FIG. 2 illustrates an example of traffic routing according to the system disclosed herein;

FIG. 3 illustrates exemplary components a traffic routing system according to the system disclosed herein; and

FIGS. 4 and 5 depict exemplary methods for implementing the traffic routing system of FIG. 3.

The detailed description explains the preferred embodiments of the invention, together with advantages and features, by way of example with reference to the drawings.

### DETAILED DESCRIPTION OF THE INVENTION

Disclosed herein is a routing system that provides for early warning and rerouting of vehicles in order to prevent and therefore avoid congestion. In general terms, the routing system includes a load balancing system as a central data repository and processing unit. The load balancing system cooperates with a plurality of vehicular units to provide route information to respective drivers or users. The routing system makes use of global positioning system (GPS) signals from GPS satellites. The routing system may also receive other inputs. The routing system determines route information in order to prevent congestion.

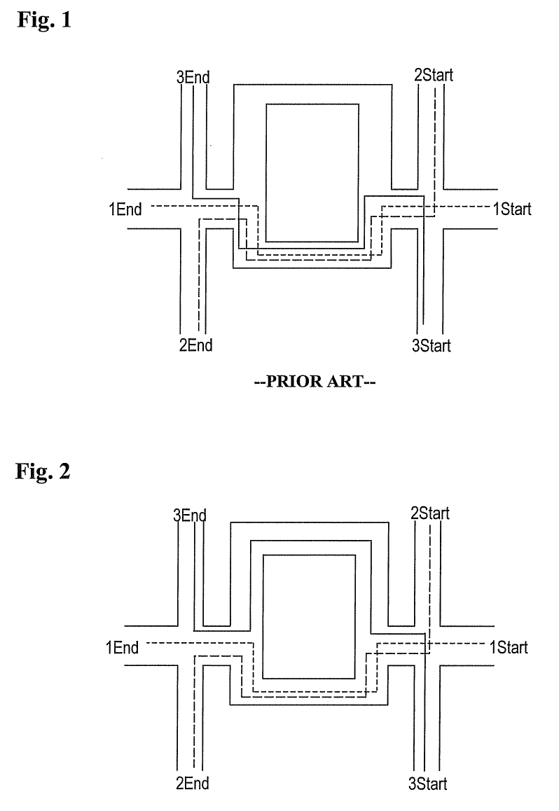

Referring now to FIG. 1, an exemplary traffic management problem is depicted. FIG. 2 depicts a solution to the problem of FIG. 1 provided in accordance with the teachings herein.

In FIG. 1, three separate vehicles (1, 2 and 3) commence traveling a route (denoted as 1Start, 2Start and 3Start) respectively. In this example, each of the vehicles 1, 2, 3 is provided a conventional route by a routing system using global positioning system (GPS) information. As may be noted with reference to FIG. 1, the three vehicles depicted are all routed along one route, although these vehicles are traveling to separate destinations.

For this example, congestion is realized when more than two cars traverse a road segment at the same time. Accordingly, use of conventional navigation systems leads to congestion. The teachings herein provide a routing system that prevents congestion from occurring. The prevention provides for generally congestion free driving to a given destination.

As used herein, the term “congestion” refers to a road condition that exhibits slower speeds, longer trip times, and increased queuing when compared to an average state of operation. Congestion occurs when roadway demand is greater than capacity. Also as used herein, the term “road segment” refers to a portion of a road bounded by two end points. Generally, no two road segments overlap. A “route” is composed of at least one road segment, and generally includes a plurality of road segments.

With reference to FIG. 2, an example is provided where the routing system has provided rerouting for vehicle 3. By use of the routing system, congestion is avoided (and traffic in the main thorough fare of FIG. 1 is reduced). As may be noted, the route taken by vehicle 3 in this example is considerably longer (and therefore not a preferred route). However, by use of congestion data as discussed herein, the routing system is able to provide vehicle 3 with a revised route that avoids congestion and provides for expedient travel.

In this example, where only a few vehicles are involved, it is easily recognized that having an appreciable portion of the traffic using the routing system disclosed herein actually provides for reduction or elimination of congestion. Accordingly, other drivers without the routing system in their respective vehicle benefit from use of the routing system. Thus, the routing system may be used to at least one of avoid and prevent congestion.

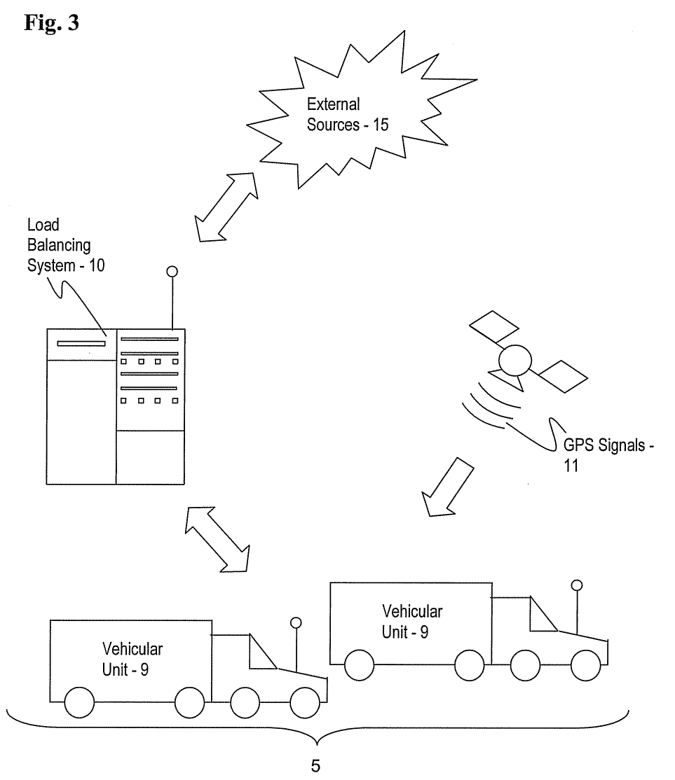

Using FIG. 1 and FIG. 2 as perspective, FIG. 3 depicts aspects of the routing system 5. The routing system 5 includes a load balancing system 10, input from the GPS signals 11, a vehicular unit 9 and may include input from external source 15.

The load balancing system 10 maintains information needed to determine road segment congestion and calculate revised route information. The load balancing system 10 evaluates how many vehicles might “congest” a segment by performing various calculations. The load balancing system 10 then suggests detours to drivers if it determines that congestion may be realized. Accordingly, the load balancing system 10 uses various sources of congestion data, initial coordinate information and destination information to determine and provide route information. One source of congestion data is the initial destination. Using the initial destination, the system can predict the load on a road segment.

In operation, a driver of a vehicle (such as a car, truck, motorcycle, bicycle or other such vehicle) inputs a desired destination into the vehicular unit 9. In conventional navigation systems, such a unit would simply use various software instructions with reference to map data and present location information to display or otherwise provide a route. However, in the routing system 5 disclosed herein, the vehicular unit 9 includes additional functionality to provide for improved route information. Exemplary and non-limiting additional functionality includes equipment for two-way communication (such as via 802.11 protocols, cellular systems and other such systems as may be known in the art); processing systems (that may include a display, memory, storage, a user interface, a communications interface, a power supply and other such components) which may include machine readable and executable instructions stored on machine readable media within the vehicular unit 9, where such instructions may govern on-board systems, manage input and output as well as communication and to provide for certain other aspects of the routing system 5.

In general, the load balancing system 10 includes communications interfaces for communicating with vehicular units 5. Other communications interfaces on-board the load balancing system 10 may be included and provide for communication with external sources 15. Exemplary and non-limiting external sources 15 include public and private traffic information systems, as well as input from drivers (such as by way of calls to a call center) and other such sources of information. The load balancing system 10 generally includes components as are known in the art of computing infrastructures. Exemplary components include: at least one processor, memory, storage, a system bus, a network interface, a user interface, a display, a pointing device, a keyboard, a wireless interface, a printer interface, communications equipment, database software tools, algorithms and others.

The load balancing system 10 may be implemented in a variety of ways. In a first embodiment, the vehicle will receive current location coordinates from the GPS signals 11. Once the current location coordinates are received, an initial route will be calculated and divided into road segments. The vehicular unit 9 will then contact the load balancing system 10 using a communications interface. Relevant information from a data repository of the load balancing system 10 will then be obtained to assist the load balancing system 10 with predicting congestion data for each segment. Once prediction data is determined, broadcast to the vehicular unit 9 and received therein, the vehicular unit 9 will calculate a revised route that avoids potentially congested road segments. Various criteria may be used for determining if the revised route is preferable to the initial route. For example, the load balancing system 10 may use: certain statistical analyses (such as by comparing estimated or actual traffic counts to roadway capacity and then determining a ranking for each revised path, or by other such factors); demographic information (such as accounting for day and time and typical correlating traffic patterns and other such factors); road condition information (such as by considering construction, road age or wear, and other such factors). Combinations of these foregoing techniques and others may be used as determined appropriate.

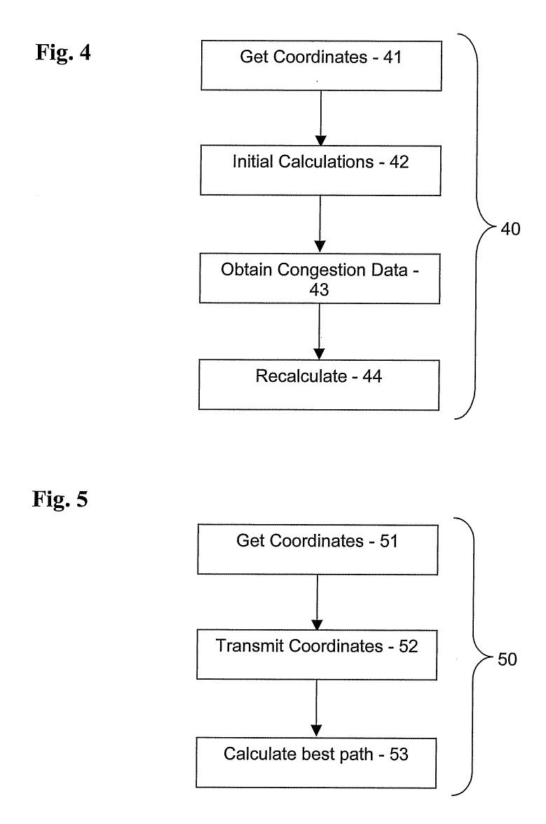

The process for determining route information 40 is further described with reference to FIG. 4. In FIG. 4, the user provides coordinates 41 to the load balancing system 10. The routing system 5 then completes initial calculations 42 (by use of at least one of the load balancing system 10 and the vehicular unit 9). The routing system 5 then obtains congestion data 43 from the load balancing system 10. Recalculation 44 is completed to improve the route information.

In another embodiment, described with reference to FIG. 5, the routing system 5 provides for determining route information 50. In this example, the vehicular unit 9 will determine current location information 51 from the GPS signals 11. Once coordinates are received, the coordinates are transmitted 52 to the load balancing system 10 along with a final destination for the travel. The routing system 5 will calculate a route 53 for the vehicle avoiding paths with potential congestion.

Although the routing system 5 may determine various statistics about a road segment, that may not provide adequate information for determining whether to send a vehicle there or not. Accordingly, the routing system 5 may maintain current, real time and projected information about capacity for a road segment. The routing system 5 may use that information in conjunction with statistical or other information to select revised routes for each vehicle.

In order to predict potential congestion per road segment, the load balancing system 10 may be equipped to maintain various information for each segment. Exemplary and non-limiting information that may be maintained includes: at least one of start coordinates and end coordinates for a road segment; speed limit for the road segment; a vehicle capacity for the road segment; a current vehicle load for the road segment; current GPS coordinates for the vehicular unit; speed information; demographic information comprising average traffic count according to day and time; as well as construction information and associated impact information; and other such information. Of course, the routing system 5 may also provide for derivation of other useful information from these and other aspects.

One embodiment for keeping the congestion data current includes developing awareness in the routing system 5 of the actual travel path traversed by a vehicle. In this example, the load balancing system 10 is updated with active and current coordinates for any one or more vehicle. This is to ensure that the number of current vehicles per road segment is accurate so that future congestion prevented routes will be correctly predicted. For example, if the vehicular unit 9 sent location information to the load balancing system 10, the system 10 may continue to verify that the vehicle is moving along its assigned path and update road segment congestion prediction appropriately. In short, the routing system 5 may include adaptive techniques for improving information used to determine routing.

One skilled in the art will recognize that a variety of capabilities may be implemented in the routing system 5. Further, these capabilities may be implemented by at least one of the load balancing system 10 and the vehicular unit 9. That is, fulfillment of at least some of the capabilities may be shared between the load balancing system 10 and the vehicular unit 9. Accordingly, the embodiments provided herein are merely illustrative and are not limiting of the teachings herein.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A routing system comprising:
at least one vehicular unit comprising a global positioning system (GPS) receiver for receiving coordinate information, an interface for receiving destination information and a processing system adapted for two-way communications; and
a load balancing system adapted for receiving the coordinate information and the destination information from the at least one vehicular unit and determining a route from congestion data and the information.

2. The routing system as in claim 1, wherein the congestion data comprises at least one of start coordinates and end coordinates for a road segment; speed limit for the road segment; a vehicle capacity for the road segment; a current loading of vehicles for the road segment; current GPS coordinates for the vehicular unit; speed information; demographic information comprising average traffic count according to day and time; as well as construction information and associated impact information.

3. The routing system as in claim 1, wherein the route is determined from at least one of a statistical analysis; demographic information; road condition information and a combination thereof.

4. The routing system as in claim 3, wherein statistical analysis is comprised of comparing at least one of estimated and actual traffic counts to roadway capacity and then determining a ranking for each road segment.

5. The routing system as in claim 3, wherein the demographic information comprises at least one of day and time and correlating traffic patterns for each road segment.

6. The routing system as in claim 3, wherein the condition information comprises information regarding at least one of construction, road age and road wear.

7. The system as in claim 1, wherein the system is further adapted for maintaining current, real time and projected information about capacity for a road segment

8. The routing system as in claim 1, further comprising machine executable instructions stored on machine readable media, the instructions providing for determining the route from congestion data and the information.

9. A method for determining route information for routing from an initial location to a destination, the method comprising:
determining initial coordinates from global position system (GPS) information;
calculating an initial route to the destination;
evaluating congestion data associated with the route information; and
recalculating the route information to at least one of avoid and prevent congestion.

10. A routing system comprising:
at least one vehicular unit comprising a global positioning system (GPS) receiver for receiving coordinate information, an interface for receiving destination information and a processing system adapted for two-way communications; and
a load balancing system adapted for receiving the coordinate information and the destination information from the at least one vehicular unit and determining a route from congestion data and the information;
wherein the congestion data comprises at least one of start coordinates and end coordinates for a road segment; speed limit for the road segment; a vehicle capacity for the road segment; a current loading of vehicles for the road segment; current GPS coordinates for the vehicular unit; speed information; demographic information comprising average traffic count according to day and time; as well as construction information and associated impact information;
wherein the route is determined from at least one of a statistical analysis; demographic information; road condition information and a combination thereof.
